(19) United States
(12) Patent Application Publication
(10) Pub. No.: US 2023/0394361 A1
(43) Pub. Date: Dec. 7, 2023

(54) MACHINE LEARNING MODEL SEARCH USING META DATA

(71) Applicant: DataRobot, Inc., Boston, MA (US)

(72) Inventors: Ho Nian Chua, Singapore (SG); Michael Schmidt, Washington, DC (US); Zachary Meyer, Cohasset, MA (US); Senbong Gee, Singapore (SG); Mark Steadman, Watertown, MA (US); Alex Conway, Boston, MA (US); Lingjun Kang, Chantilly, VA (US)

(73) Assignee: DataRobot, Inc., Boston, MA (US)

(21) Appl. No.: 18/204,108

(22) Filed: May 31, 2023

Related U.S. Application Data
(60) Provisional application No. 63/348,762, filed on Jun. 3, 2022.

(51) Int. Cl. G06N 20/00

(52) U.S. Cl. CPC G06N 20/00

(57) ABSTRACT

Machine learning model searching using meta data is provided. A system receives, via a graphical user interface from a client device, a request to search for one or more blueprints including one or more models to add to a project. The system can identify, based on a selection, a list of features with which to execute the requested search. The system can provide a blueprint including a model selected from projects established via input from client devices different from the client device, the projects including blueprints, the blueprints including models trained by machine learning. The system can train, via machine learning, the model of the blueprint to determine the target and add the blueprint including the trained model to the project. The system can generate data causing the graphical user interface to display an indication of the blueprint including the trained model.

### CROSS-REFERENCE TO RELATED PATENT APPLICATION

This application claims, under 35 U.S.C. § 119, the benefit of, and priority to, U.S. Provisional Patent Application No. 63/348,762 filed Jun. 3, 2022, the entirety of which is incorporated by reference herein.

### TECHNICAL FIELD

The present implementations relate generally to machine learning and machine learning models.

### BACKGROUND

A machine learning system can train models based on training datasets. The machine learning system can implement training techniques that determine values for various parameters or weights of the models. The models can execute on other datasets to make model decisions, predictions, or other inferences based on the various values for the parameters or weights.

### SUMMARY

For a large machine learning problem, there can be a significantly large number of possible solutions, making it technically challenging and computationally resource intensive to search for, and identify, solutions that can address the machine learning problem with a desired level of performance. A heuristic search of a subset of a search space of the large number of solutions can be time and resource intensive. For example, the search can execute by testing a set of pre-defined solutions or evolving a random solution. This technical solution is directed to machine learning model search using meta data. A system of this technical solution can learn using data collected from the application of a variety of machine learning solutions to a variety of problems (e.g. cold-start modeling). The system can improve model suggestions by using the accuracy results of a first model or first set of models (e.g., linear models or decision trees) on a given dataset (e.g. warm-start modeling). The system can rank a set of suggested solutions using a ranking model trained from the performance history of a set of solutions on different machine learning problems. The suggested solutions can be provided by an automatic machine learning heuristic or another source. The system can provide the ranked models as suggestions to users, from the highest ranked model to lower ranked models. The system can maintain a list of surviving model solutions and suggestions to user's projects (e.g. to collect accuracy levels or performance data for the generated models). Upon collecting performance data on these models, the system can identify which models perform accurately, and then activate, invoke, use, or otherwise suggest those models for implementation.

An aspect of this technical solution is directed to a system. The system can include a data processing system including one or more processors, coupled with memory. The data processing system can receive, via a graphical user interface from a client device, a request to search for one or more blueprints including one or more models to add to a project configured to deploy the one or more models trained via machine learning. The data processing system can identify, based on a selection received from the client device via the graphical user interface, a list of features with which to execute the requested search. The data processing system can provide, responsive to execution of the search with the list of features, a blueprint including a model selected from projects established via input from client devices different from the client device, the projects including blueprints, the blueprints including models trained by machine learning to determine a target based on a list of features. The data processing system can train, via machine learning, the model of the blueprint to determine the target and add the blueprint including the trained model to the project. The data processing system can generate data causing the graphical user interface to display an indication of the blueprint including the trained model.

The project can include the blueprints, the blueprints including the models trained by machine learning to determine the target based on the list of features to determine the target. The project can include second blueprints, the second blueprints including a second models trained on a second list of features to determine the target. The data processing system can generate data causing the graphical user interface to display an indication of the list of features and the second list of features. The data processing system can receive, via the graphical user interface, a user input that identifies the list of features.

The project can include second blueprints, the second blueprints including second models trained on a second list of features to determine the target. The data processing system can receive a user input via the graphical user interface that identifies the second list of features. The data processing system can compare a number of the second models to a threshold to determine that the number of the second models is less than the threshold. The data processing system can generate data causing the graphical user interface to display an indication that the number of the second models is less than the threshold.

The data processing system can compare performance levels of the blueprints including the models with a second performance levels of a second blueprints including second models of the projects. The data processing system can select a particular project from the projects based on the comparison. The data processing system can select the blueprint including the model from particular blueprints including particular models of the particular project.

The data processing system can fit performance levels of the blueprints including the models of the project and particular performance levels of particular blueprints including particular models of a particular project of the projects to a linear relationship. The data processing system can determine a level of the fit to the linear relationship. The data processing system can select the particular project from the projects responsive to the level satisfying a threshold. The data processing system can select the blueprint including the model from the particular blueprints including the particular models.

The data processing system can generate a first vector including performance levels of the blueprints including the models. The data processing system can generate a second vector including particular performance levels of particular blueprints including particular models of a particular project of the projects. The data processing system can compute a cosine of an angle formed by the first vector and the second vector. The data processing system can select the particular project from the projects responsive to the cosine of the angle or the angle satisfying a threshold. The data processing system can select the blueprint including the model from the particular blueprints including the particular models.

The data processing system can perform singular value decomposition to decompose the projects into a representation of the projects. The data processing system can identify, based on the representation of the projects, a particular project of the plurality of projects. The data processing system can select the blueprint including the model from a plurality of particular blueprints including a plurality of particular models of the particular project.

The data processing system can receive, via the graphical user interface, a second request to search for a second blueprint including a second model to add to the project. The data processing system can search the projects based on the list of features and the blueprints including the models and the blueprint including the trained model to identify the second blueprint including the second model. The data processing system can train the second model of the second blueprint by machine learning to determine the target and add the second blueprint including the second trained model to the project. The data processing system can generate data causing the graphical user interface to display an indication of the second blueprint including the second trained model.

The data processing system can generate data causing the graphical user interface to be displayed by a computing system, the graphical user interface including a button to execute the search. The data processing system can receive, via the graphical user interface, an interaction with the button. The data processing system search the projects responsive to a reception of the interaction.

The data processing system can generate data causing the graphical user interface to include a list of the blueprints including the models and the blueprint including the trained model. The data processing system the list ordered based on performance levels of the blueprints including the models and a performance level of the blueprint including the trained model.

The data processing system can search the projects with characteristics of at least one of the list of features, the blueprints, or the models.

An aspect of this disclosure can be directed to a method. The method can be performed by a data processing system comprising one or more processors coupled with memory. The method can include the data processing system receiving, via a graphical user interface from a client device, a request to search for one or more blueprints including one or more models to add to a project configured to deploy the one or more models trained via machine learning. The method can include the data processing system identifying, based on a selection received from the client device via the graphical user interface, a list of features with which to execute the requested search. The method can include the data processing system providing, responsive to execution of the search with the list of features, a blueprint comprising a model selected from a plurality of projects established via input from a plurality of client devices different from the client device. The plurality of projects can include a plurality of blueprints. The plurality of blueprints can include a plurality of models trained by machine learning to determine a target based on a list of features. The method can include the data processing system training, by the data processing system via machine learning, the model of the blueprint to determine the target and add the blueprint including the trained model to the project. The method can include the data processing system generating data causing the graphical user interface to display an indication of the blueprint including the trained model.

An aspect of this disclosure can be directed to a non-transitory computer-readable medium storing process-executable instructions that, when executed by one or more processors, cause the one or more processors to receive, via a graphical user interface from a client device, a request to search for one or more blueprints including one or more models to add to a project configured to deploy the one or more models trained via machine learning. The instructions can include instructions to identify, based on a selection received from the client device via the graphical user interface, a list of features with which to execute the requested search. The instructions can include instructions to provide, responsive to execution of the search with the list of features, a blueprint comprising a model selected from a plurality of projects established via input from a plurality of client devices different from the client device, the plurality of projects including a plurality of blueprints, the plurality of blueprints including a plurality of models trained by machine learning to determine a target based on a list of features. The instructions can include instructions to train, via machine learning, the model of the blueprint to determine the target and add the blueprint including the trained model to the project. The instructions can include instructions to generate data causing the graphical user interface to display an indication of the blueprint including the trained model.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 is a block diagram of a data processing system that performs meta-learning, in accordance with present examples.

FIG. 2 is a graphical user interface including a list of blueprints and models, in accordance with present examples.

FIG. 3 is a graphical user interface including an element to select a feature list, in accordance with present examples.

FIG. 4 is a graphical user interface including the element of FIG. 3 including indications of multiple feature lists that the feature list can be selected from, in accordance with present examples.

FIG. 5 is a graphical user interface including the element of FIG. 3 including an indication that a feature list includes a number of models less than a threshold, in accordance with present examples.

FIG. 6 is a graphical user interface including elements indicating blueprints and models identified via a search, in accordance with present examples.

FIG. 7 is a graphical user interface including the list of blueprints and models of FIG. 2 and the blueprints and models identified via the search, in accordance with present examples.

FIG. 8 is a method of performing meta-learning, in accordance with present examples.

FIG. 9 is an example of the data processing system of FIG. 1, in accordance with present examples.

FIGS. 10-15 depict display screens or portions thereof with graphical user interfaces, in accordance with present examples.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

This disclosure is generally directed to systems and methods for meta-learning. A machine learning project can include blueprints. Each blueprint can define a set of processes that, when executed, determine a target based on a variety of input features. The blueprint can be a directed graph or a directed acyclic graph that includes nodes representing the processes. The blueprint can include edges connecting the nodes representing the order in which the processes are performed. The blueprint can include at least one model. The model can be represented as one node of the graph. The model can be trained by machine learning to output a value for the target based on values of the input features.

A machine learning project can include multiple blueprints and models each trained on the same set of features to determine the target. The machine learning project can further include blueprints and models trained on other sets of features to determine the target. The machine learning project can rank the blueprints and models according to their performance in generating the target. To identify a blueprint and model that performs well in identifying the target, a significant number of blueprints and models may be developed, trained, tested, and compared against each other. Furthermore, the blueprints and models can be adjusted, designed, tested, redesigned, and retested by a system. This iterative process can be inefficient for a computing system to perform. For example, the large number of blueprints and models that may be developed, stored, trained, and executed by a processing system can result in a substantial usage of memory and processing resources. Furthermore, the long amount of time taken to train the models for the project can result in processor or memory devices operating in high current sourcing states for an extended duration of time, causing substantial amounts of power to be consumed.

To solve these and other technical problems, the system described herein can perform meta-learning. The system can efficiently identify blueprints and models for a project based on the meta-learning. The system can use knowledge identified in past machine learning projects to drive the selection, training, and deployment of blueprints and models to other machine learning projects. For example, various client devices can create machine learning projects to determine a target based on a set of features. The client devices can modify the blueprints or models of the projects to generate blueprints or models that perform well in determining the target. The system can perform meta-learning to leverage this work in designing high performing models by searching through the blueprints and models of the client devices to select a blueprint or model that would perform well for another machine learning project in question. This can allow the system to quickly and efficiently identify blueprints and models for a machine learning project without developing a significant number of blueprints or models to be stored, trained, or executed. This can save substantial amounts of processing resources and memory resources. Furthermore, because the system can quickly and efficiently identify the blueprints and models for the machine learning project. The system can cause computing devices or memory devices to reduce the amount of time that they spend in a high current sourcing state, thus reducing the amount of power used to develop a machine learning project.

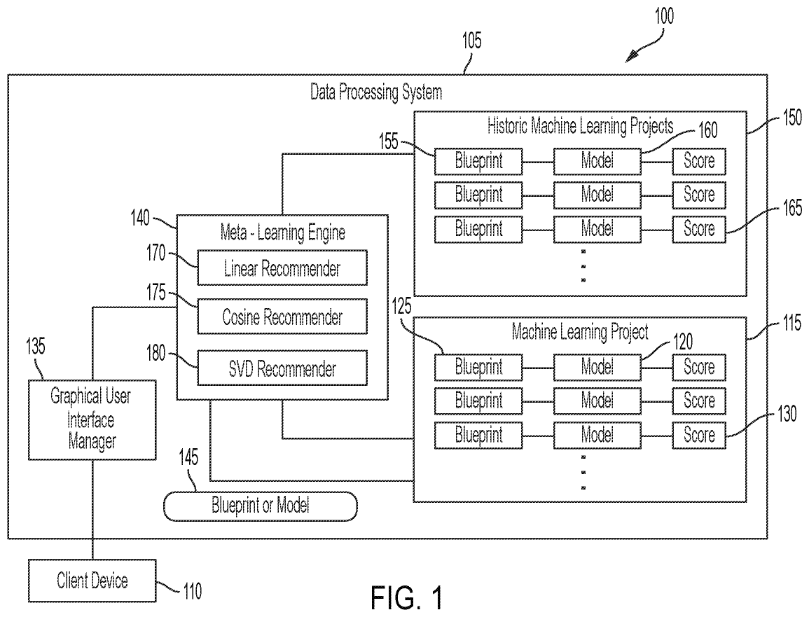

FIG. 1 is a block diagram of a system 100 including a data processing system 105 that performs meta-learning, in accordance with present examples. The data processing system 105 can be a server system, a cloud computing platform, a local computing system, a laptop computer, a desktop computer, a client device, or any other system that can process information. The data processing system 105 can transmit data to, or receive data from, at least one client device 110. The client device 110 can transmit data to, or receive data from, the data processing system 105. The data processing system 105 and the client device 110 can communicate via at least one network. The network can include a local area network (LAN), a wide area network (WAN), a metropolitan area network (MAN). The network can include the Internet. The network can include a Wi-Fi network. The network can include a cellular network (e.g., 3G, 4G, 5G, 6G).

The client device 110 can provide a training dataset for training a machine learning project 115. The client device 110 can provide a training dataset in a file of a particular file format. The file can be a comma separated value (CVS) file, a tab separated value (TSV) file, a data source view (DSV) file, an EXCEL spreadsheet (XLS) file, an EXCEL Open Extensible Markup Language (XML) Spreadsheet (XLSX) file, a Statistical Analysis System 7BDAT (SAS7BDAT) file, a geographic JavaScript Object Notation (GEOJSON) file, a GNU zipped (GZ) file, a BZ1 file, a tape achieve file (TAR) file, a TGZ file, or a zipped (ZIP) file. The client device 110 can provide a training dataset that includes a variety of features. The features can be individual measurable properties that a machine learning model can train on or generate inferences on. The features can include categorical features, numerical features, text features, location features, Boolean features, or any other type of feature.

The client device 110 can identify a target in the training dataset. For example, a user can enter a name, select a column, enter a name of a property, select a particular variable in the training dataset, etc. to be the target. The target can be the property that the machine learning project 115 is trained to determine, predict, or identify a value for. The target can be predicted or inferred by the machine learning project 115. The data processing system 105 can generate at least one feature list for the machine learning project 115. The data processing system 105 can receive selections of feature lists from a user via the client device 110. For example, the data processing system 105 can identify features in the training dataset and display the features to a user. A user can select various features from the displayed features to create a feature list. Furthermore, the data processing system 105 can perform an analysis of the training dataset with the target to identify a list of features that have a particular level of influence in determining the target, e.g., a selection of the most, or highly influential, features.

The data processing system 105 can train the machine learning project 115 based on the training dataset. The data processing system 105 can train the machine learning project 115 based on the feature list. The data processing system 105 can train models 120 based on the training dataset and the feature lists. For each feature list, the data processing system 105 can train a set of models 120 to determine the target with values of the features of the feature list as inputs into the set of models 120. For example, the data processing system 105 can train first blueprints 125 and models 120 based on data of a first feature list of the machine learning project 115. The data processing system 105 can train second blueprints 125 and second models 120 based on data of a second feature list of the machine learning project 115. The data processing system 105 can train blueprints 125 and models 120 for any number of feature lists of the machine learning project 115.

Each model 120 can be a model of a blueprint 125. The blueprint 125 can be a directed graph (DG) that includes nodes representing processes or models and edges representing the order of execution of the processes or models. The blueprint 125 can be a directed acyclic graph (DAG) that includes nodes representing processes and edges representing the order of execution of the processes. The DAG can be acyclic because the edges and nodes do not form any recursion or cycle. The nodes of the blueprints 125 can representing input data, output predictions, output inferences, one or more of the models 120, one-hot encoding, data cleansing, transforms, word-gram analysis, and various other pre-processing steps (actions that are performed on data before the model 120 is executed), processing steps, and post processing steps (actions that are performed on the output of the model 120).

The models 120 can be or include neural networks. For example, the models 120 can be convolutional neural networks (CNN), recurrent neural networks (RNN), sequence to sequence neural networks, long-short term neural networks (LSTM), or any other kind of neural network. The models 120 can be or include gradient boost models. The models 120 can be or include random forest classifiers. The models 120 can be or include XGboost models. The models 120 can be or include logistic regressions. The models 120 can be or include gradient descent classifiers. The models 120 can be or include ridge regressors. The models 120 can be or include elastic-net regressors.

The data processing system 105 can generate a score 130 for each blueprint 125 and model 120. The data processing system 105 can test each blueprint 125 and model 120 to determine how well the blueprint 125 and the model 120 determines the target. The score 130 can indicate a performance level, e.g., a level at which the blueprint 125 and the model 120 performs in determining the target. The score 130 can be a log loss value, an error value, a percentage value indicating a number of times that the model 120 determines the target properly, a grade value (e.g., A, B, C, D), a rate at which the model 120 determines the correct target.

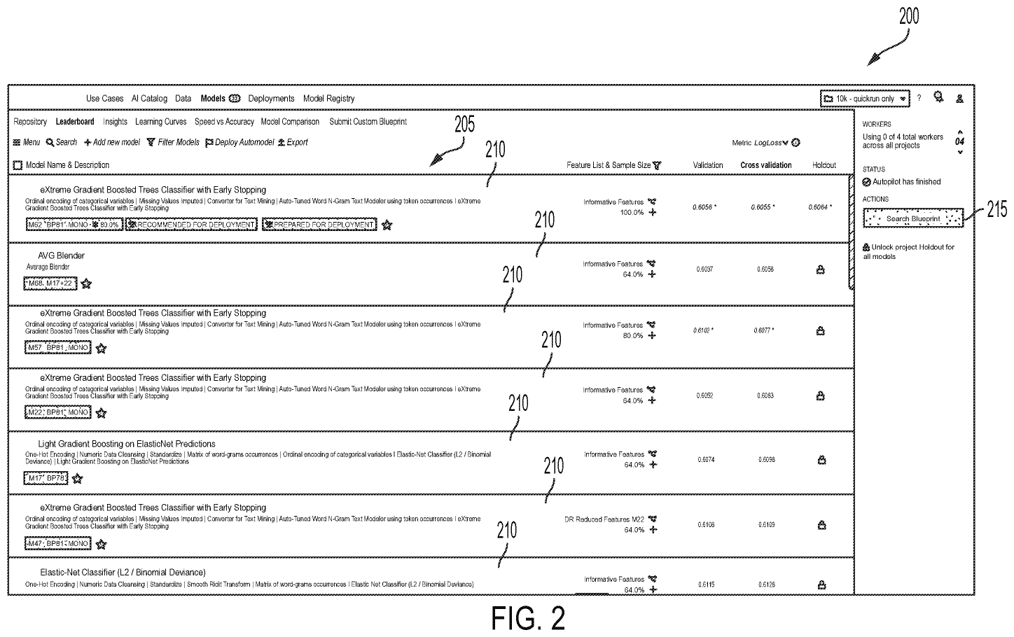

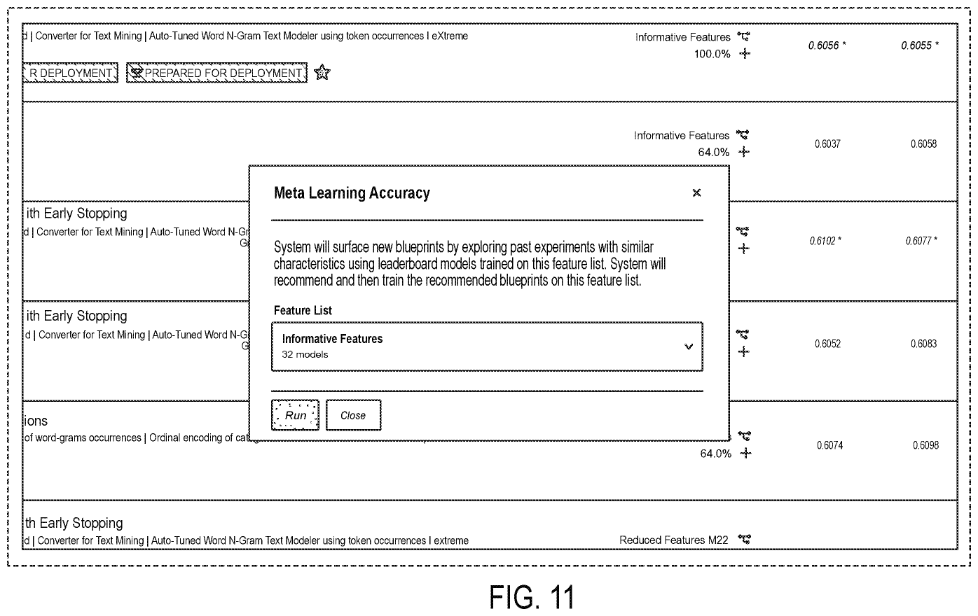

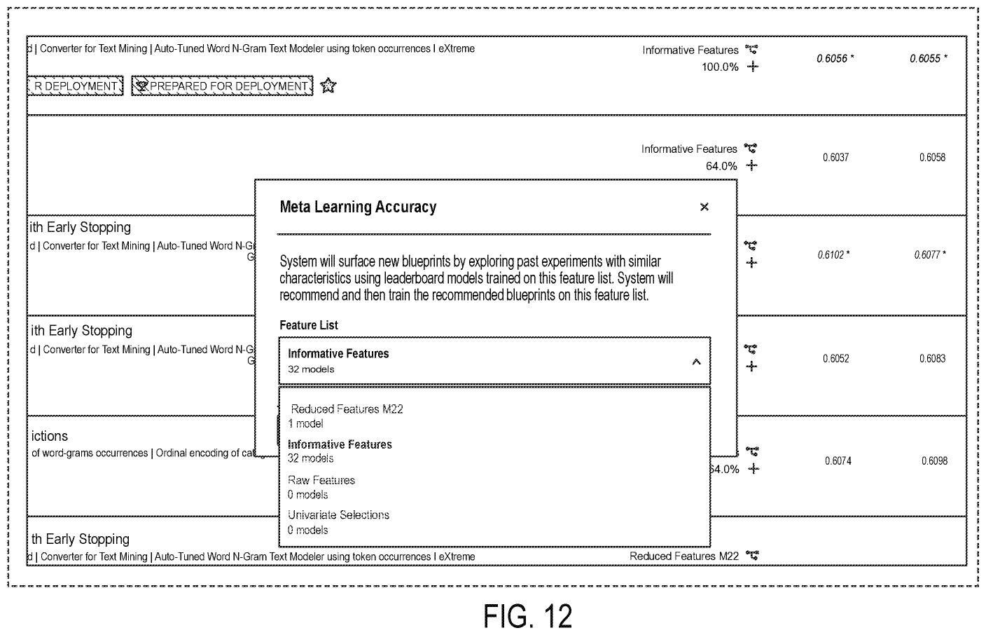

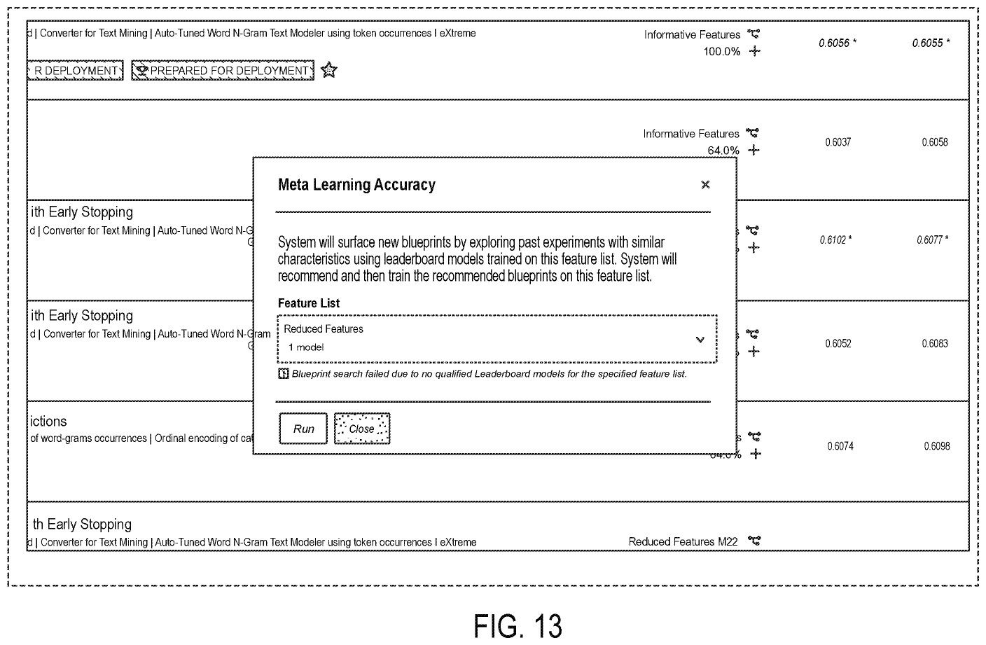

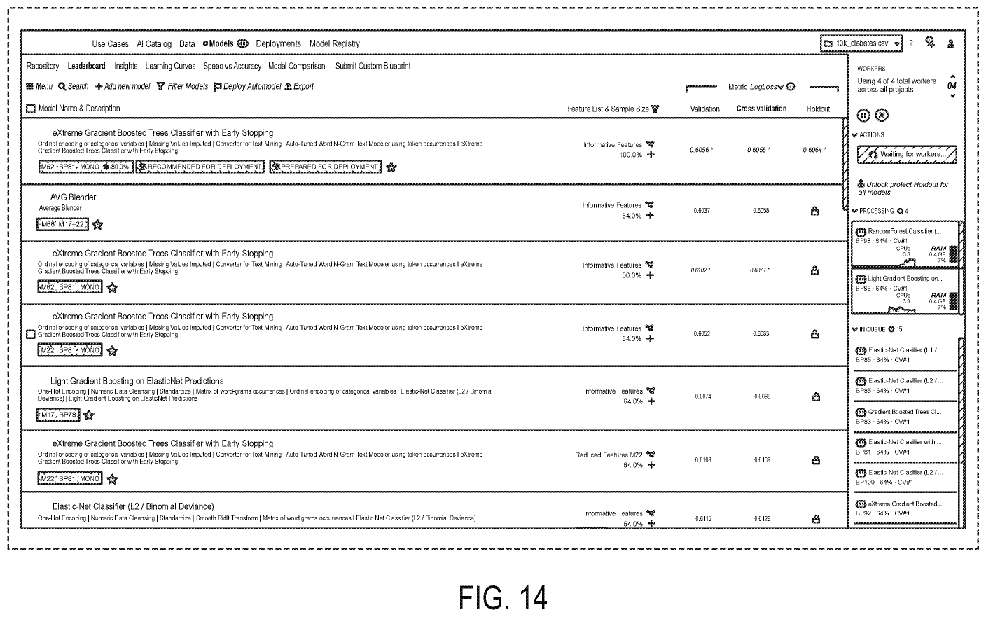

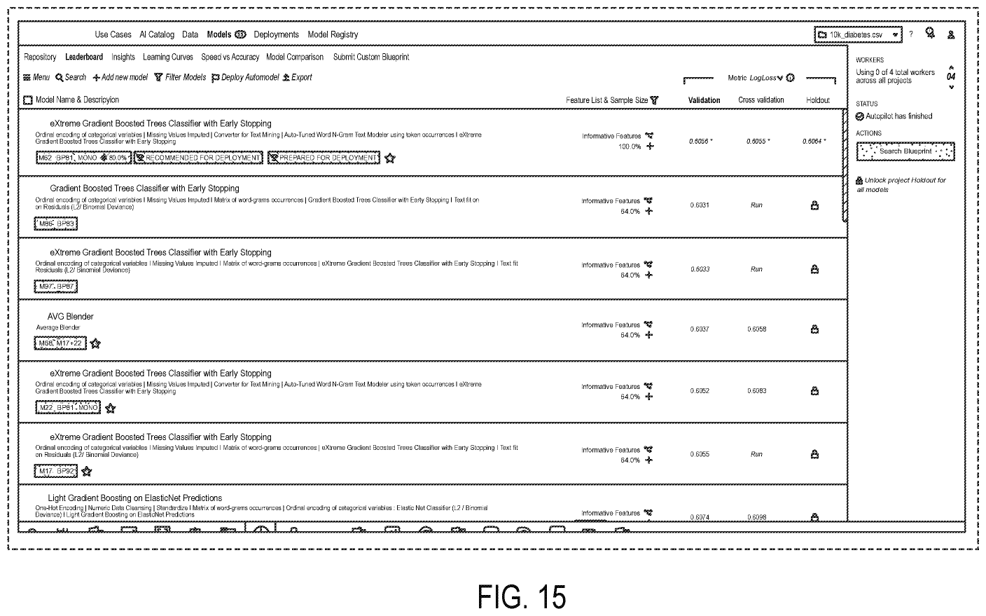

The data processing system 105 can include a graphical user interface manager 135. The graphical user interface manager 135 can generate a graphical user interface. The graphical user interface manager 135 can generate data that causes the client device 110 to display a graphical user interface. The graphical user interface manager 135 can receive data that identifies interactions made by the client device 110 with various user interface elements, buttons, switches, input elements, etc. of the graphical user interface. The graphical user interface manager 135 can generate data that modifies the appearance of a graphical user interface displayed on the client device 110. The graphical user interface manager 135 can cause the client device 110 to display the graphical user interfaces described at FIGS. 2-7 or FIGS. 10-15.

The data processing system 105 can include an interface. The interface can be an application programming interface (API) that can include or be associated with an API library that can be stored by the client device 110. The client device 110 can run API instructions of the API library to interact with the data processing system 105. The interface can provide data (e.g., the blueprint or model 145, the machine learning project 115, the historic machine learning projects 150) to the client device 110. The data processing system 105 can receive inputs from the client device 110 via the interface, e.g., a request to perform a meta-learning search, a selection of feature list, a selection to implement a blueprint or model, etc. Via the interface, the client device 110 can programmatically initiate the meta-learning engine 140 to perform meta-learning and receive results of the meta-learning. The client device 110 can interact with the data processing system 105 with the interface instead of (or in addition to) utilizing a graphical user interface. The interface can expose all of the data of the graphical user interfaces described herein. The interface can receive all of the input data provided by the client device 110 via the graphical user interfaces described herein.

A user, via the client device 110, can review the scores 130 of the blueprints 125 and the models 120. The graphical user interface manager 135 can display a list of blueprints 125 and models 120. The list can be ordered from highest scores 130 to lowest scores 130. The list can include a recommendation to deploy the highest performing blueprint 125 and the model 120. A user can make a selection of a blueprint 125 and model 120, via the client device 110. The machine learning project 115 can deploy the blueprint 125 and the model 120 responsive to the selection. The machine learning project 115 can deploy the blueprint 125 and the model 120 to determine the target based on inference data sets, e.g., datasets received from the client device 110, via an application, via an Internet of Things (IoT) system, or any other data input system.

The graphical user interface manager 135 can receive a request to perform a search for at least one new blueprint or new model to add to the machine learning project 115 from the client device 110. For example, a user, via the client device 110, can interact with a search button of a graphical user interface displayed on the client device 110 by the graphical user interface manager 135. Responsive to a user interacting with the search button, at least one meta-learning engine 140 of the data processing system 105 can search for one or multiple blueprints including one or multiple models to add to the machine learning project 115.

A user can select a feature list via a graphical user interface displayed by the client device 110. The graphical user interface can display a variety of feature lists of the machine learning project 115. The graphical user interface can display the number of blueprints 125 or models 120 trained for each individual feature list. A user, via the client device 110, can identify or select a feature list from the graphical user interface for performing a meta-learning search. The data processing system 105 can compare a number of models 120 trained for a selected feature list to a threshold. For example, the threshold can define a number of models to properly perform the meta-learning search. The comparison of the number of models 120 trained for the selected list to the threshold can allow the data processing system 105 to determine whether the number of models is greater than the threshold, equal to the threshold, or less than the threshold.

If the number of models is greater than or equal to the threshold (e.g., satisfies the threshold), the graphical user interface manager 135 can generate data that causes a graphical user interface displayed on the client device 110 to indicate that the meta-learning engine 140 can search for blueprints and models based on the feature list and the blueprints and models of the feature list. The graphical interface can display an indication that the number of models is greater than or equal to the threshold. If the number of models is less than the threshold (e.g., does not satisfy the threshold), the graphical user interface manager 135 can generate data that causes a graphical user interface displayed on the client device 110 to indicate that the meta-learning engine 140 cannot search for blueprints and models based on the feature list and the blueprints and models of the feature list. The graphical interface can display an indication that the number of models is less than the threshold.

The meta-learning engine 140 can perform a meta-learning search that identifies at least one recommended blueprint and model 145. The meta-learning engine 140 can search for blueprints and models based on the feature list selected by the user and the models trained to determine the target based on the selected feature list. The meta-learning engine 140 can add the recommended blueprint and model 145 to the machine learning project 115. The recommended blueprint and model 145 can be trained on the feature list to determine the target.

The meta-learning engine 140 can search at least one historic machine learning project 150 for at least one blueprint and at least one model of blueprints 155 and models 160 of the historic machine learning projects 150. The historic machine learning projects 150 can be similar to the machine learning project 115. The blueprints 155 can be similar to the blueprints 125. The models 160 can be similar to the models 120. The scores 165 can be similar to the scores 130. Each of the historic machine learning projects 150 can be developed by a particular client device, e.g., a client device different or separate from the client device 110. For example, a variety of other users can provide their own training datasets via their client devices, define feature lists for the training datasets, select, modify, or design blueprints and models for training by machine learning on the feature lists, deploy blueprints and models, combine certain blueprints with certain models, etc.

The data processing system 105 can anonymize the historic machine learning projects 150. For example, because each historic machine learning project 150 can be a machine learning project developed by a particular client device 110 and include private information, the data processing system 105 can identify the private information and remove the private information from the historic machine learning projects 150. For example, a user, via the client device 110, can review the historic machine learning project 150 and identify private information in the historic machine learning projects 150. The data processing system 105 can remove the private information from the historic machine learning projects 150 based on the user input. The data processing system 105 can automatically search through the historic machine learning projects 150 and identify information in the historic machine learning projects 150 that is private. The data processing system 105 can remove the private information from the historic machine learning project 150.

The meta-learning engine 140 can identify a particular historic machine learning project 150 from the historic machine learning projects 150 based on the search. The particular historic machine learning project 150 can be identified as being similar to the machine learning project 115. The meta-learning engine 140 can identify the particular historic machine learning project 150 by comparing the feature list of the machine learning project 115 with a feature list of the historic machine learning projects 150 to determine a level of similarity. For example, if the feature list of the historic machine learning project 150 includes similar textual information describing features of the feature list of the machine learning project 115, the particular historic machine learning project 150 can be selected. Furthermore, blueprints 125 and models 120 can be compared to the blueprints 155 and models 160 of the historic machine learning projects 150. Furthermore, the meta-learning engine 140 can compare the blueprints 125 with the blueprints 155 of the historic machine learning projects 150 to identify a particular historic machine learning project 150 that uses similar blueprints. Furthermore, the meta-learning engine 140 can compare the model 120 with the model 160 of the historic machine learning projects 150 to identify a particular historic machine learning project 150 that uses similar models. If a particular historic machine learning project 150 is similar to the machine learning project 115, it can be inferred that the blueprints 155 or the models 160 of the particular historic machine learning project 150 can be appropriate for use in the machine learning project 115.

The meta-learning engine 140 can compare the scores 130 of the machine learning project 115 (or the scores 130 of the blueprints 125 and models 120 trained on the selected feature list) against scores 165 of the historic machine learning projects 150. The scores 130, or a distribution of the scores 130, can provide a fingerprint or identifiable characteristic of the machine learning project 115 that can be searched against the historic machine learning projects 150 to identify a blueprint and model 145 to add to the machine learning project 115. The fingerprint or identifiable characteristic can be used by the meta-learning engine 140 to identify a particular historic machine learning project 150. The meta-learning engine 140 can select at least one blueprint or model 145 from the particular historic machine learning project 150. The scores 130 or the distribution of the score 130 can be used to identify what types of models work best for the historic machine learning projects 150. The meta-learning engine 140 may not need to analyze the design of the blueprint 125, the model 120, the blueprints 155, or the models 160 if the scores 130 and the scores 165 are used to identify similar machine learning projects.

For example, the meta-learning engine 140 can compare the scores 130 against the scores 165 of each historic machine learning project 150. The meta-learning engine 140 can determine a similarity level between the scores 130 and the scores 165. The meta-learning engine 140 can select one historic machine learning project 150 from the historic machine learning projects 150 based on the comparison. For example, the meta-learning engine 140 can select a particular historic machine learning project 150 that has a highest similarity level to the machine learning project 115. The meta-learning engine 140 can analyze the particular historic machine learning project 150 and select at least one blueprint and model from the particular historic machine learning project 150. For example, the meta-learning engine 140 can select a highest performing blueprint and model 145 from the particular machine learning project 150 or a number of the highest performing blueprint and models 145 of the particular historic machine learning project 150.

The meta-learning engine 140 can include a linear recommender 170. The linear recommender 170 can select a particular historic machine learning project 150 from the historic machine learning projects 150 based on the machine learning project 115. The linear recommender 170 can fit the scores 130 and the scores 165 of each historic machine learning project 150 to a linear relationship, e.g., a line. For example, the linear recommender 170 can perform a linear regression with the scores 130 and the scores 165. The linear recommender 170 can identify a fit level for each historic machine learning project 150. The fit level can indicate how well the scores 165 of each historic machine learning project 150 and the machine learning project 115 fit the linear relationship. The fit level can indicate a level of error in the scores 165 and the scores 130 fitting the linear relationship. The fit level can indicate how wells the scores 165 and the scores 130 fit the linear relationship. The higher the fit level (or lower if the fit level indicate an error), the higher the similarity between the machine learning project 115 and the historic machine learning project 150.

The linear recommender 170 can select a particular historic machine learning project 150 from the historic machine learning projects 150 that has a linear relationship greater than a level with the machine learning project 115. The linear recommender 170 can select the particular historic machine learning project 150 from the historic machine learning projects 150 by comparing the linear fit level of each historic machine learning project 150 and selecting a particular historic machine learning project 150 associated with a highest linear fit level. The linear recommender 170 can determine that the linear fit level of the particular historic machine learning project 150 satisfies a threshold, e.g., is greater than a particular level or is the highest linear fit level. The linear recommender 170 can select at least one blueprint or model 145 from the particular historic machine learning project 150 to be trained and added to the machine learning project 115. The linear recommender 170 can select a highest performing blueprint and model from the particular historic machine learning project 150, e.g., a blueprint and model associated with a highest score 165. A user may review the blueprints 155, models 160, or scores 165 of the particular historic machine learning project 150 via the client device 110 and make one or more selections of the blueprints or models 145.

The meta-learning engine 140 can include a cosine recommender 175. The cosine recommender 175 can generate vectors for the machine learning project 115 and each historic machine learning project 150. For example, the cosine recommender 175 can generate a vector based on the scores 130 for the machine learning project 115. The cosine recommender 175 can generate the vector based on a ranking of the blueprints 125 and the models 120 by the scores 130 for the machine learning project 115. The vector can include the scores 130 in an order based on decreasing value of the scores 130 or based on increasing value of the scores 130. The cosine recommender 175 can generate a vector for each historic machine learning project 150 based on the scores 165 for each machine learning project 150. The cosine recommender 175 can generate the vector based on a ranking of the blueprints 155 and the models 160 of each historic machine learning project 150 by the scores 165 for each historic machine learning project 150. The vector can include the scores 165 in an order based on decreasing value of the scores 165 or increasing value of the scores 165.

The cosine recommender 175 can determine a cosine value of an angle formed between a first vector for the machine learning project 115 and a second vector of each historic machine learning project 150. For example, the cosine recommender 175 can determine a dot product of the first vector and the second vector. The cosine recommender 175 can determine a magnitude of the first vector and a magnitude of the second vector. The cosine recommender 175 can determine the cosine of the angel formed between the first vector and the second vector by dividing the dot product of the first vector and the second vector by the magnitude of the first vector times the magnitude of the second vector.

If the angle formed between the first vector and the second vector is zero (e.g., the cosine of the angle is one) this indicates that the first vector and the second vector are identical. The closer the angle between the first vector and the second vector are to zero (e.g., the closer the cosine of the angle is to one) the more similar the two vectors may be. The cosine recommender 175 can compare the angle between the first vector and the second vector to a threshold. If the angle satisfies the threshold, e.g., is less than the threshold, the cosine recommender 175 can select the particular historic machine learning project 150 from the historic machine learning projects 150. The cosine recommender 175 can select a particular historic machine learning project 150 from the historic machine learning projects 150 that includes an angle that is closest to zero. The cosine recommender 175 can compare the cosine of the angle between the first vector and the second vector to a threshold. If the cosine of the angle satisfies the threshold, e.g., is greater than the threshold, the cosine recommender 175 can select the particular historic machine learning project 150 from the historic machine learning projects 150. The cosine recommender 175 can select a particular historic machine learning project 150 from the historic machine learning projects 150 that includes a cosine of an angle that is closest to one. The cosine recommender 175 can select at least one blueprint or model from the particular historic machine learning project 150 to be trained and added to the machine learning project 115. The cosine recommender 175 can select a highest performing blueprint and model from the particular historic machine learning project 150, e.g., a blueprint and model associated with a highest score 165.

The meta-learning engine 140 can include a singular value decomposition (SVD) recommender 180. The SVD recommender 180 can perform SVD on the historic machine learning projects 150 to decompose the historic machine learning projects into a representation of the historic machine learning projects 150. For example, the SVD recommender 180 can decompose vectors or matrixes representing the historic machine learning project 150 into the representation. The representation can be a compressed or reduced dimensionality representation of the historic machine learning projects 150. The representation can be a compact representation of the entire space of the historic machine learning projects 150. The representation can include less total information as compared to the historic machine learning project 150. However, the representation can include important or influential characteristics of the historic machine learning projects 150. The size of the reduced dimensionality representation can be selectable, e.g., selectable by a user, technician, or data scientist via the client device 110. The SVD recommender 180 can identify a particular historic machine learning project 150 to select a blueprint or model from more efficiently, in quicker manner, and with less noise since the representation includes less information but still includes the important characteristics of the historic machine learning projects 150.

The SVD recommender 180 can identify information in the collapsed or decomposed version of the historic machine learning projects 150 that indicates an important similarity between the machine learning project 115 and at least one historic machine learning project 150. The SVD recommender 180 can use the learned information from the collapsed or decomposed version of the historic machine learning projects 150 to recommend blueprints or models 145 of the higher dimension representation of the historic machine learning projects 150 to be added to the machine learning project 115. In some cases, a historic machine learning project 150 and the machine learning project 115 may appear dissimilar or not highly similar in the full space. However, in the collapsed space, the historic machine learning project 150 and the machine learning project 115 may appear more similar, e.g., the collapsed version of the historic machine learning projects 150 can capture the more important information that drives similarity. For example, the SVD recommender 180 can analyze the collapsed representation of the historic machine learning project 150 to identify a particular historic machine learning project 150. The SVD recommender 180 return to the full representation of the historic machine learning projects 150 and select a blueprint or model 145 from the identified particular historic machine learning project 150.

The meta-learning engine 140 can compare characteristics of the machine learning project 115 against characteristics of the historic machine learning projects 150. The meta-learning engine 140 can compare characteristics of the blueprints 125 against characteristics of the blueprints 155. The meta-learning engine 140 can compare characteristics of the models 120 against characteristics of the models 160. The meta-learning engine 140 can compare characteristics of a selected feature list against the feature lists of the historic machine learning projects 150. Based on the comparison, the meta-learning engine 140 can at least one particular historic machine learning project 150 that is similar to the machine learning project 115. The meta-learning engine 140 can compare text columns to identify similar names, similar states, similar features, etc.

The data processing system 105 can train the model of the recommended blueprint or model 145 to determine the target for the machine learning project 115 based on the feature list that the meta-learning engine 140 used to perform the search. The trained blueprint or model 145 can be added to the machine learning project 115. A user can select the trained blueprint or model 145 via the client device 110 to be deployed. The graphical user interface manager 135 can generate data that causes the client device 110 to display an indication of the recommended blueprint or model 145 or the trained blueprint or model 145.

The graphical user interface manager 135 can generate data that causes a graphical user interface to be displayed on the client device 110 or include a list of the blueprints 125 and models 120 as well as the blueprint or model 145 identified by the meta-learning engine 140. The list can rank the blueprint 125 and model 120 based on the score. Furthermore, a score of the blueprint or model 145 can be used to include and rank the blueprint and model 145 within the list. The list can be ordered from highest score to lowest score.

With the new blueprint or model 145 trained and added to the machine learning project 115, the meta-learning engine 140 can perform a search to add additional blueprints and models to the machine learning project 115. The search can search the historic machine learning projects with the blueprints 125, the models 1210, the scores 130, and the blueprint or model 145. The second search can identify additional blueprints 155 or models 160 to add to the machine learning project 115. The data processing system 105 can train the additional models to determine the target based on the feature list. The additional models and blueprints can be scored and displayed in a list of blueprints 125 and models 120 for the machine learning project 115 ranked in order of score 130 on a graphical user interface displayed on the client device 110.

FIG. 2 is a graphical user interface 200 including a list 205 of blueprints 125 and models 120, in accordance with present examples. The graphical user interface manager 135 can generate data that causes the graphical user interface 200 on the client device 110. The list 205 can include rows 210. Each row 210 can include a representation of a blueprint 125 or a model 120. For example, the row 210 can include a model number identifier, a blueprint model identifier, a name of the model or blueprint, etc. The row 210 can further indicate the score 130. The row 210 can include a validation score, a cross validation score, or a holdout score. The list 205 can include blueprints 125 and models 120 before the meta-learning engine 140 performs a search. The graphical user interface 200 can include a search button 215. A user can interact with the search button 215 via the client device 110. Responsive to a user interacting with the search button 215, the meta-learning engine 140 can run a search on the historic machine learning projects 150 to identify the blueprint or model 145.

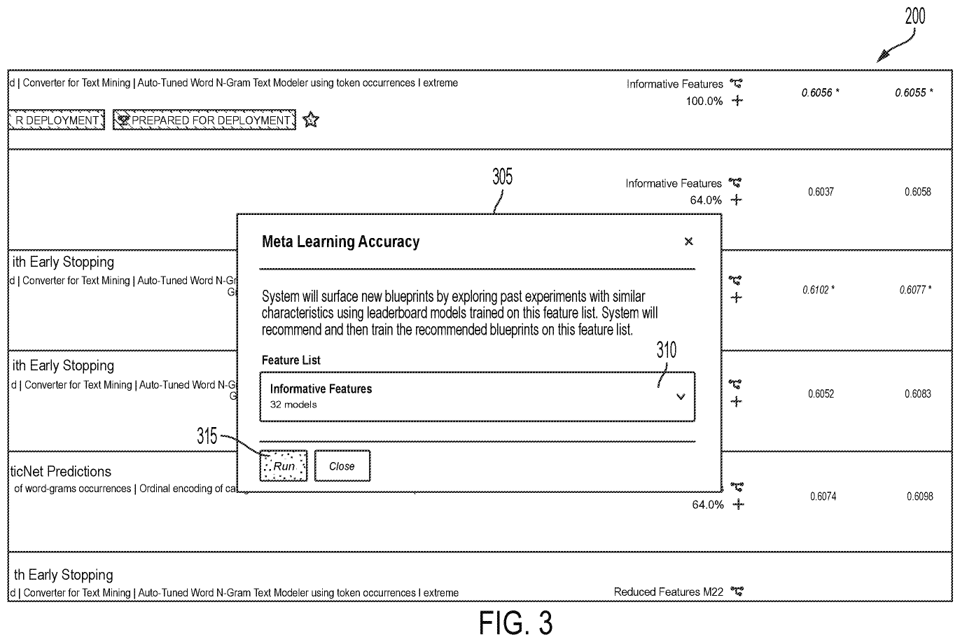

FIG. 3 is a graphical user interface 200 including an element 305 to select a feature list, in accordance with present examples. The graphical user interface manager 135 can cause the element 305 to be displayed in the graphical user interface 200 responsive to a user interacting with the search button 215. The element 305 can include a drop-down menu 310. The drop-down menu 310 can include representations of features lists of the machine learning project 115. The element 305 can further include a run button 315. Responsive to a user interacting with the run button 315 via the client device 110, the meta-learning engine 140 can perform a search to identify the blueprint and model 145 from the historic machine learning projects 150. The meta-learning engine 140 can perform the search with the feature list and the blueprints and models trained on the feature list to determine the target based on the selection of the feature list made in the drop-down menu 310. For example, if a user selects a first feature list, a first set of blueprints 125 and a first set of models 120 can be retrieved by the meta-learning engine 140 to search against the historic machine learning projects 150 to identify the blueprint or model 145. If a user selects a second feature list, a second set of blueprints 125 and a second set of models 120 can be retrieved by the meta-learning engine 140 to search against the historic machine learning projects 150 to identify the blueprint or model 145.

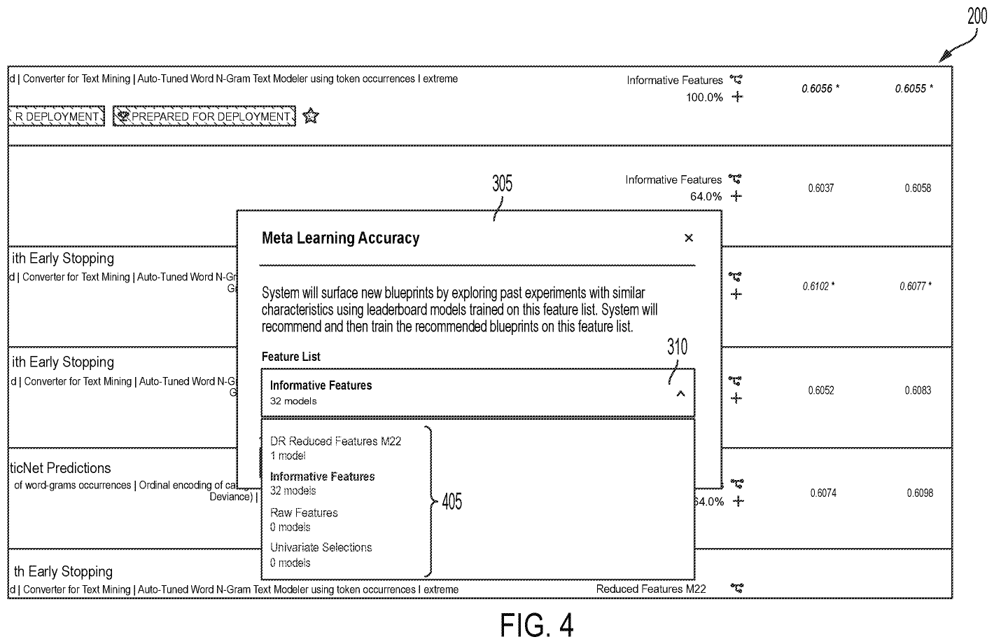

FIG. 4 is a graphical user interface 200 including the element of FIG. 3 including indications of multiple feature lists that the feature list can be selected from, in accordance with present examples. Responsive to a user interacting with the drop-down menu 310, indications 405 of feature lists can be displayed in the graphical user interface 200. The indications 405 can indicate a name of each particular feature list. Furthermore, the indications 405 can indicate the number of models 120 trained to determine a target based on each feature list. For example, a first feature list may include a single model while another feature list may include thirty two models. Yet another feature list may not include any models at all.

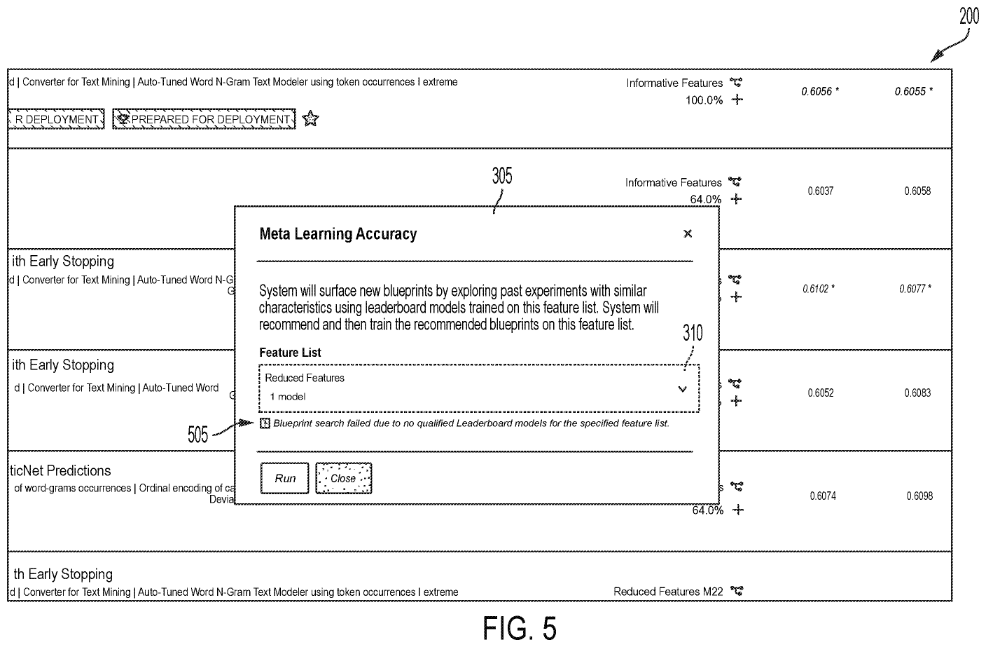

FIG. 5 is a graphical user interface 200 including the element 305 including an indication that a feature list includes a number of models less than a threshold, in accordance with present examples. Via the drop-down menu 310, a user can select a particular feature list that includes a particular number of the models 120 or blueprints 125 trained on the features of the particular feature list to determine the target. The data processing system 105 can compare the number of models 120 or blueprints 125 of the feature list to a threshold. If the number is greater than or equal to the threshold (e.g., satisfies the threshold), the data processing system 105 can determine that the meta-learning search can be performed based on the models 120 or blueprints 125 of the feature list. If the number is less than the threshold (e.g., does not satisfy the threshold), the data processing system 105 can determine that the meta-learning search cannot be performed based on the models 120 or blueprints 125 of the feature list. Responsive to determining that the meta-learning search cannot be performed the graphical user interface manager 135 can cause the element 305 to include an indication 505 that the meta-learning search cannot be performed.

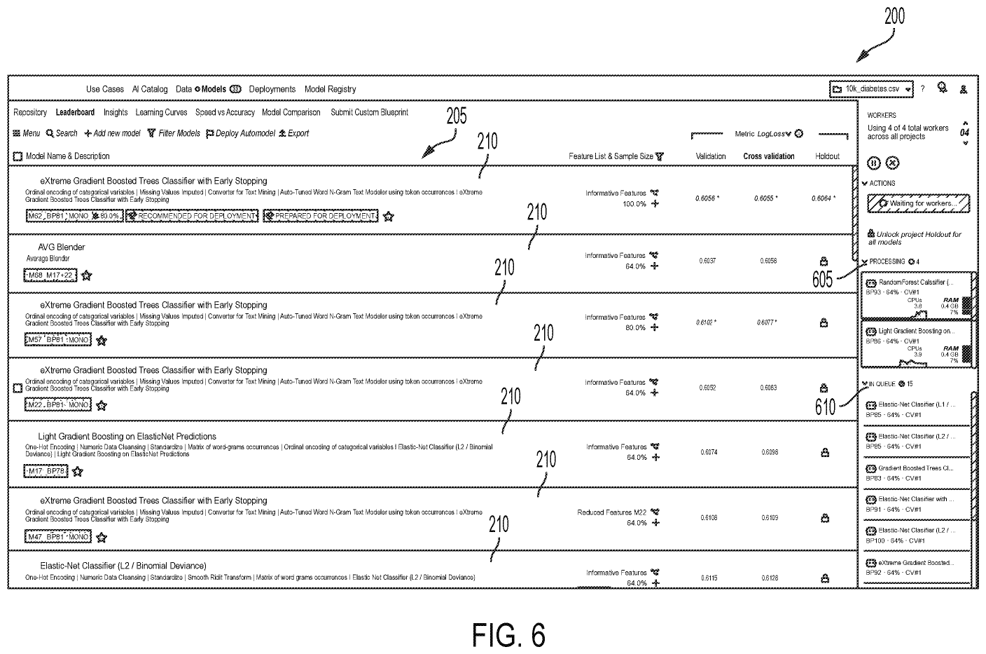

FIG. 6 is a graphical user interface 200 including elements 605-610 indicating blueprints and models identified via a search, in accordance with present examples. The element 610 can indicate a queue of blueprints or models 145 that the meta-learning engine 140 identified. The queue of blueprints or models 145 can indicate blueprints or models 145 that the data processing system 105 is waiting to train based on the feature list to determine the target. As the blueprints or models 145 are trained, the graphical user interface manager 135 can remove the models from the element 610 and display an indication of the blueprints or models 145 being trained in the element 605. The element 605 can display the blueprints or models 145 that are being trained to be added to the machine learning project 115. The element 605 can indicate each blueprint or model 145, indicate the number of central processing units (CPUs) used to train blueprint or model 145, include a plot of the number of CPUs used to train the blueprint or model 145 over time, and indicate an amount of random access memory (RAM) used to train the blueprints or models 145. Responsive to the training finishing for a blueprint or model 145, the blueprint or model 145 can be removed from the element 605 and displayed in the list 205.

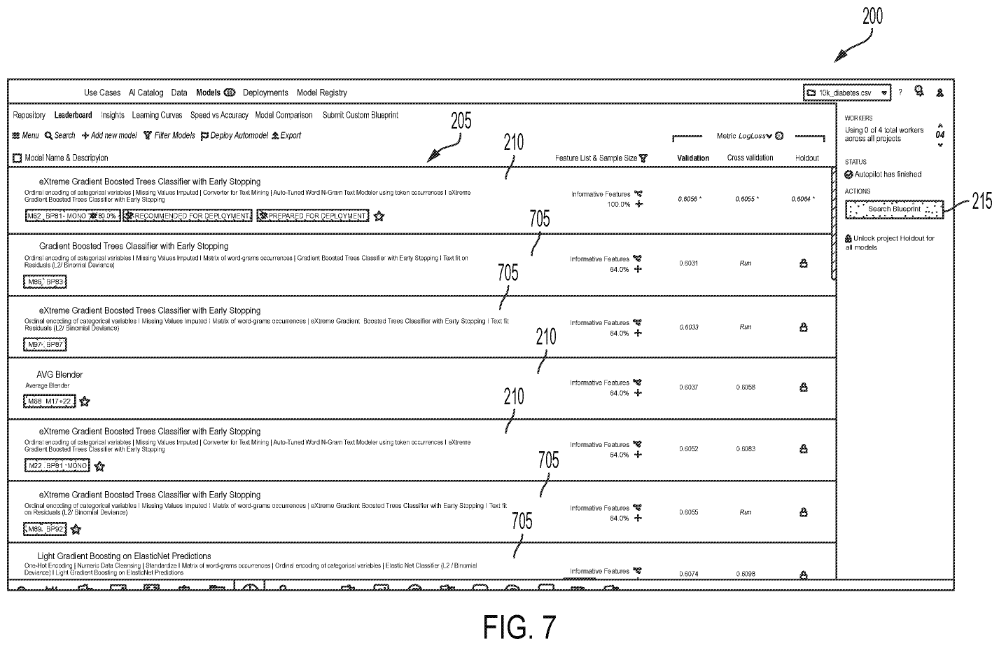

FIG. 7 is a graphical user interface 200 including a list 205 of blueprints 125 and models 120 of the machine learning project 115 and the blueprints or models 145 identified via the search, in accordance with present examples. The list 205 can include the rows 210 that represent the blueprints 125 and the models 120. The result of the search performed by the meta-learning engine 140, e.g., the trained blueprints or models 145, and be represented in the list 205 as rows 705. The rows 210 and the rows 705 can be ranked based on a score of the blueprint and model represented by each row. The graphical user interface 200 can include the search button 215. A user can interact with the search button 215 to cause the meta-learning engine 140 to run another search, e.g., a second search, a third search, a fourth search, etc. The meta-learning engine 140 can cause the element 305 to be displayed in the graphical user interface 200 prompting the user to select a feature list. The blueprints or models of the selected feature list can be used by the meta-learning engine 140 to run an additional search. The blueprints and models use to run the additional search can be the blueprints 125 and the models 120 of the original machine learning project 115 and the blueprints or models 145 added to the original machine learning project 115 by performing a previous search by the meta-learning engine 140. The result of the search can be additional blueprints or models 145. The additional blueprints or models 145 can be identified, trained, added the machine learning project 115, and displayed within the graphical user interface 200.

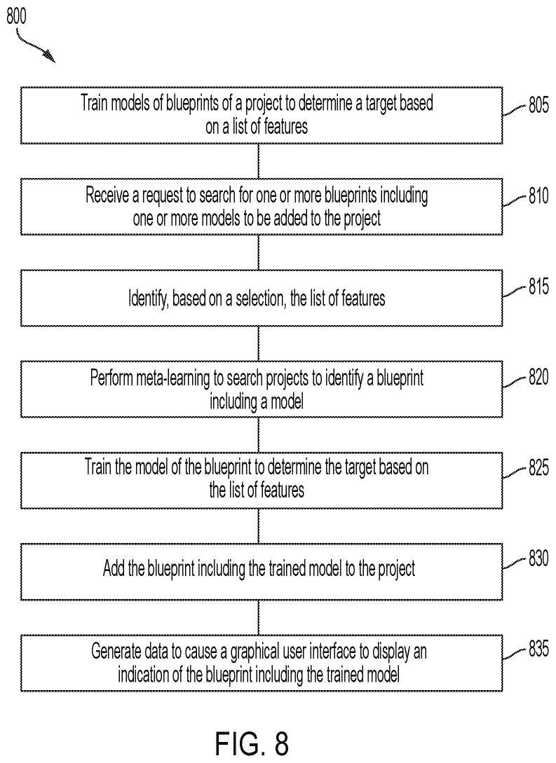

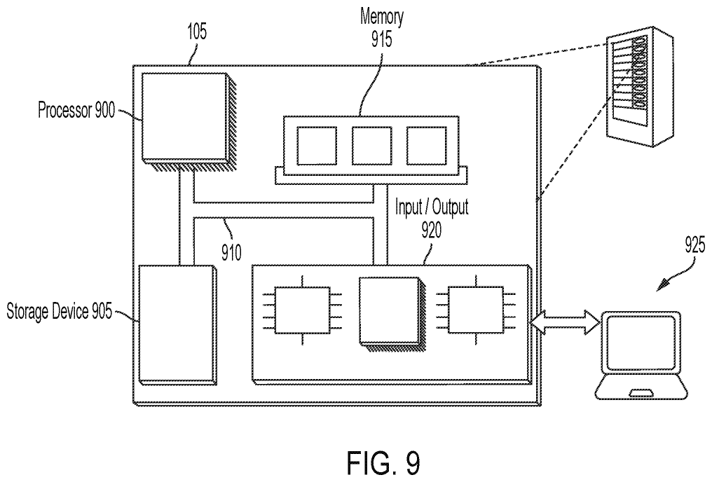

FIG. 8 is a method 800 of performing meta-learning. The data processing system 105 can perform at least one ACT of the method 800. The client device 110 can perform at least one ACT of the method 800. The computing hardware described at FIG. 9 can perform at least one ACT of the method 800. Furthermore, any computing system, device, software module, group of software modules, or other computational resources described herein can perform the method 800.

The method 800 can include an ACT 805 of training models of blueprints of a project to determine a target based on a list of features. The method 800 can include an ACT 810 of receiving a request to search for one or more blueprints including one or more models to be added to the project. The method 800 can include an ACT 815 of identifying, based on a selection, the list of features. The method 800 can include an ACT 820 of performing meta-learning to search projects to identify a blueprint including a model. The method 800 can include an ACT 825 of training the model of the blueprint to determine the target based on the list of features. The method 800 can include an ACT 830 of adding the blueprint including the trained model to the project. The method 800 can include an ACT 835 of generating data to cause a graphical user interface to display an indication of the blueprint including the trained model.

The method 800 can include an ACT 805 of training, by the data processing system 105, models 120 of blueprints 125 of the machine learning project 115 to determine a target based on a list of features. The list of features can be a selection of features of a training dataset. The training dataset can include values for each feature. The data processing system 105 can train the models 120 of the blueprints 125 based on the values of the feature list. The target can be a parameter of the training dataset. A user can select the target from the training data set via the client device 110. The user can select the feature list from the training dataset via the client device 110. The data processing system 105 can identify or recommend feature lists to the client device 110. The user, via the client device 110, and accept, decline, or modify the feature list recommended by the data processing system 105.

The method 800 can include an ACT 810 of receiving, by the data processing system 105, a request to search for one or more blueprints including one or more models 145 to be added to the machine learning project 115. A user, via the client device 110, can interact with elements of a graphical user interface displayed on the client device 110 to request the search. For example, the graphical user interface manager 135 can cause the client device 110 to display the graphical user interface 200 including the search button 215. A user can interact with the search button 215 via the client device 110, e.g., press the search button 215. The data processing system 105 can cause the meta-learning engine 140 to perform the search responsive to the user interacting with the search button 215.

The method 800 can include an ACT 815 of identifying, by the data processing system 105, based on a selection, the list of features. The machine learning project 115 can train the models 120 of the blueprints 125 based on a variety of feature lists to determine the target. The graphical user interface manager 135 can retrieve an indication of each feature list from the machine learning project 115. The graphical user interface manager 135 can cause the graphical user interface 200 to include an element 305 that includes a drop-down menu 310. The element 305 can be displayed responsive to a user interacting with the search button 215 of the graphical user interface 200 via the client device 110. The drop-down menu 310 can allow a user, via the client device 110, to select a feature list from the feature lists. The data processing system 105 identify the feature list in the machine learning project 115 responsive to receiving the selection.

The method 800 can include an ACT 820 of performing, by the data processing system 105, meta-learning to search the historic machine learning projects 150 to identify the blueprint including the model. The meta-learning engine 140 can search the historic machine learning projects 150 with the selected feature list to identify a particular historic machine learning project 150 that uses a similar feature list. The meta-learning engine 140 can search the historic machine learning projects 150 with the blueprint 125, the model 120, or the score 130 to identify a particular historic machine learning project 150 that is similar to the machine learning project 115. For example, the linear recommender 170 can fit the scores 130 and the scores 165 to a linear relationship to determine whether the machine learning project 115 and a particular historic machine learning project 150 are similar (e.g., have a linear fit level above a particular level). The cosine recommender 175 can compute a cosine of an angle formed between a vector of scores 165 and a vector of scores 130. The cosine recommender 175 can compare angle or cosine of the angel to a threshold to determine how similar the machine learning project 115 is with each of the historic machine learning projects 150. The SVD recommender 180 can decompose the historic machine learning projects 150 into a representation of the historic machine learning projects 150 and then search the representation with the machine learning project 115 to identify a particular historic machine learning project 150 similar to the machine learning project 115. The meta-learning engine 140 can select at least one blueprint including at least one model from at least one identified particular historic machine learning project 150 that is similar to the machine learning project 115.

The method can include an ACT 825 of training, by the data processing system 105, the model of the blueprint 145 to determine the target based on the list of features. The data processing system 105 can train the model of the blueprint based on training data of the training data set. For example, values of the training dataset for the list of features used selected at ACT 815 can be used to train the model of the blueprint.

The method can include an ACT 830 of adding, by the data processing system 105, the blueprint including the trained model 145 to the machine learning project 115. For example, the data processing system 105 can save the trained blueprint and model to the machine learning project 115. The data processing system 105 can test the trained model of the blueprint 145 and generate a score 130 for the model. The method 800 can include an ACT 835 of generating, by the data processing system 105, data that causes a graphical user interface 200 to display an indication of the blueprint including the trained model 145. For example, the graphical user interface manager 135 can modify the graphical user interface 200 to display an indication of the blueprint and model 145 and a score 130 of the blueprint and model 145. The graphical user interface manager 135 can create a row 705 in the graphical user interface 200. For example, the row 705 can represent a blueprint and model identified by the meta-learning engine 140 and trained by the data processing system 105.

FIG. 9 is a block diagram of an example of the data processing system 105. The data processing system 105 can include or be general-purpose computers, network appliances, mobile devices, servers, cloud computing systems, or other electronic systems. The data processing system 105 can include at least one processor 900, at least one memory 915, at least one storage device 905, and at least one input/output device 920. The processor 900, the memory 915, the storage device 905, and the input/output device 920 can be interconnected, for example, using at least one system bus 910. The processor 900 can process instructions for execution within the data processing system 105. The processor 900 can include a single-threaded processor. The processor 900 can include a multi-threaded processor. The processor 900 can process instructions stored in the memory 915 or on the storage device 905. The processor 900 can be a CPU, a graphics processing unit (GPU), an application specific integrated circuit (ASIC), a system on a chip (SOC), a microprocessor, or any other processing component.

The memory 915 can store information within the data processing system 105. The memory 915 can include a non-transitory computer-readable medium. The memory 915 can include a volatile memory unit. The memory 915 can include a non-volatile memory unit. The memory 915 can include RAM, dynamic RAM (DRAM), static RAM (SRAM), read only memory (ROM), double data rate 4 synchronous dynamic (DDR4) RAM, programmable ROM (PROM), electrically erasable PROM (EEPROM), or any other type of memory. The storage device 905 can provide mass storage for the data processing system 105. The storage device 905 can include a non-transitory computer-readable medium. The storage device 905 can include a hard disk device (HDD), an optical disk device, a solid-date drive (SSD), a flash drive, or some other large capacity storage device. The storage device 905 can store long-term data (e.g., database data, file system data, etc.).

At least one input/output device 920 can perform input/output operations for the data processing system 105. The input/output device 920 can include one or more of a network interface devices, e.g., an Ethernet card, a universal serial bus (USB) connection, a serial communication device, e.g., an RS-232 port, and/or a wireless interface device, e.g., a Wi-Fi card (e.g., an 802.11 card), a 3G wireless modem, a 4G wireless modem, or a 5G wireless modem. In some implementations, the interface device 925 can include driver devices configured to receive input data and send output data to other input/output systems, e.g., keyboard, printer and display devices. The interface device 925 can include smartphones, laptops, tablets, desktop computers, printers, speakers, microphones, or other devices. The data processing system 105 can be a component of the interface device 925.

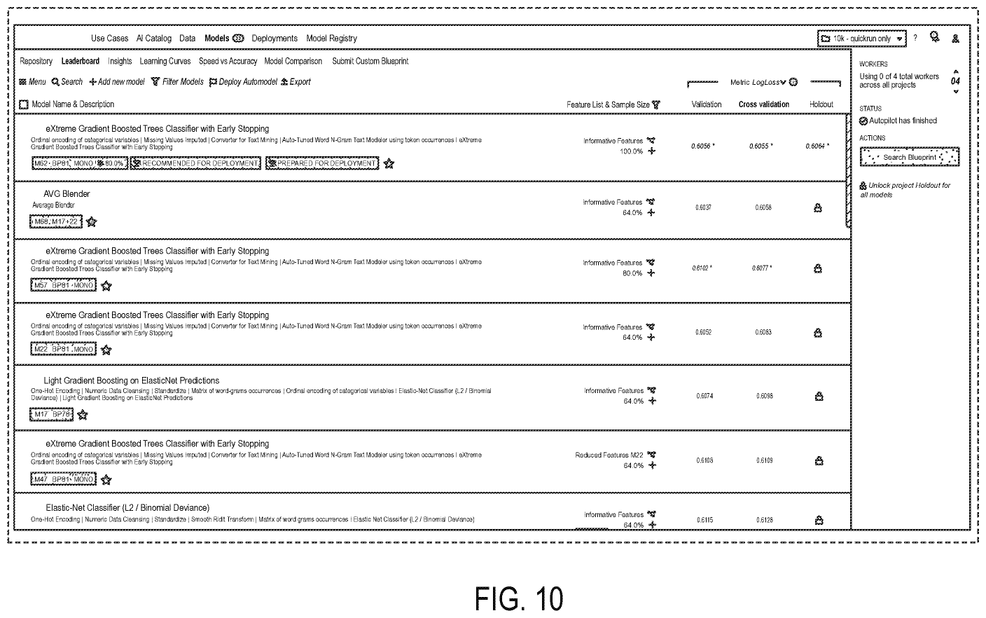

FIGS. 10-15 depict display screens or portions thereof with example graphical user interfaces. The outermost broken lines in FIGS. 10-15 illustrate the display screen or portion thereof. The graphical user interfaces may be generated, provided, and/or otherwise included with one or more embodiments described herein. Various modifications to the depicted graphical user interfaces are contemplated, such as certain of the depicted elements of one graphical user interface may be added to another graphical user interface, one or more depicted elements of certain graphical user interfaces may be removed, and/or other modifications (e.g., various graphical user interfaces may be linked together as a sequence of images to form an animated graphical user interface sequence). Further, the depicted graphical user interfaces may include various colors, color combinations, and/or other visual elements (e.g., textures, patterns, etc.) to illustrate contrasts in appearance. Moreover, modifications of the values of any depicted numbers, words, and letters is contemplated with such changes intended to fall within the scope of the disclosure. Thus, the depicted graphical user interfaces may have a variety of different appearances.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods can be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A system, comprising:
a data processing system comprising one or more processors, coupled with memory, to:
receive, via a graphical user interface from a client device, a request to search for one or more blueprints including one or more models to add to a project configured to deploy the one or more models trained via machine learning;
identify, based on a selection received from the client device via the graphical user interface, a list of features with which to execute the requested search;
provide, responsive to execution of the search with the list of features, a blueprint comprising a model selected from a plurality of projects established via input from a plurality of client devices different from the client device, the plurality of projects including a plurality of blueprints, the plurality of blueprints including a plurality of models trained by machine learning to determine a target based on a list of features;
train, via machine learning, the model of the blueprint to determine the target and add the blueprint including the trained model to the project; and
generate data causing the graphical user interface to display an indication of the blueprint including the trained model.

2. The system of claim 1, the project comprising:
the plurality of blueprints, the plurality of blueprints including the plurality of models trained by machine learning to determine the target based on the list of features to determine the target;
a second plurality of blueprints, the second plurality of blueprints including a second plurality of models trained on a second list of features to determine the target;
generate data causing the graphical user interface to display an indication of the list of features and the second list of features; and
receive, via the graphical user interface, a user input that identifies the list of features.

3. The system of claim 1, comprising:
the project comprising:
a second plurality of blueprints, the second plurality of blueprints including a second plurality of models trained on a second list of features to determine the target; and
the data processing system to:
receive a user input via the graphical user interface that identifies the second list of features;
compare a number of the second plurality of models to a threshold to determine that the number of the second plurality of models is less than the threshold; and
generate data causing the graphical user interface to display an indication that the number of the second plurality of models is less than the threshold.

4. The system of claim 1, comprising the data processing system to:
compare a plurality of performance levels of the plurality of blueprints including the plurality of models with a second plurality of performance levels of a second plurality of blueprints including a second plurality of models of the plurality of projects;
select a particular project from the plurality of projects based on the comparison; and
select the blueprint including the model from a plurality of particular blueprints including a plurality of particular models of the particular project.

5. The system of claim 1, comprising the data processing system to:
fit a plurality of performance levels of the plurality of blueprints including the plurality of models of the project and a plurality of particular performance levels of a plurality of particular blueprints including a plurality of particular models of a particular project of the plurality of projects to a linear relationship;
determine a level of the fit to the linear relationship;
select the particular project from the plurality of projects responsive to the level satisfying a threshold; and
select the blueprint including the model from the plurality of particular blueprints including the plurality of particular models.

6. The system of claim 1, comprising the data processing system to:
generate a first vector including a plurality of performance levels of the plurality of blueprints including the plurality of models;
generate a second vector including a plurality of particular performance levels of a plurality of particular blueprints including a plurality of particular models of a particular project of the plurality of projects;
compute a cosine of an angle formed by the first vector and the second vector;
select the particular project from the plurality of projects responsive to the cosine of the angle or the angle satisfying a threshold; and
select the blueprint including the model from the plurality of particular blueprints including the plurality of particular models.

7. The system of claim 1, comprising the data processing system to:
perform singular value decomposition to decompose the plurality of projects into a representation of the plurality of projects;
identify, based on the representation of the plurality of projects, a particular project of the plurality of projects; and
select the blueprint including the model from a plurality of particular blueprints including a plurality of particular models of the particular project.

8. The system of claim 1, comprising the data processing system to:
receive, via the graphical user interface, a second request to search for a second blueprint including a second model to add to the project;
search the plurality of projects based on the list of features and the plurality of blueprints including the plurality of models and the blueprint including the trained model to identify the second blueprint including the second model;
train the second model of the second blueprint by machine learning to determine the target and add the second blueprint including the second trained model to the project; and
generate data causing the graphical user interface to display an indication of the second blueprint including the second trained model.

9. The system of claim 1, comprising the data processing system to:
generate data causing the graphical user interface to be displayed by a computing system, the graphical user interface comprising a button to execute the search;
receive, via the graphical user interface, an interaction with the button; and
search the plurality of projects responsive to a reception of the interaction.

10. The system of claim 1, comprising the data processing system to:
generate data causing the graphical user interface to include a list of the plurality of blueprints including the plurality of models and the blueprint including the trained model; and
the list ordered based on a plurality of performance levels of the plurality of blueprints including the plurality of models and a performance level of the blueprint including the trained model.

11. The system of claim 1, comprising the data processing system to:
search the plurality of projects with characteristics of at least one of the list of features, the plurality of blueprints, or the plurality of models.

12. A method, comprising:
receiving, by a data processing system comprising one or more processors coupled with memory, via a graphical user interface from a client device, a request to search for one or more blueprints including one or more models to add to a project configured to deploy the one or more models trained via machine learning;
identifying, by the data processing system, based on a selection received from the client device via the graphical user interface, a list of features with which to execute the requested search;
providing, by the data processing system, responsive to execution of the search with the list of features, a blueprint comprising a model selected from a plurality of projects established via input from a plurality of client devices different from the client device, the plurality of projects including a plurality of blueprints, the plurality of blueprints including a plurality of models trained by machine learning to determine a target based on a list of features;
training, by the data processing system via machine learning, the model of the blueprint to determine the target and add the blueprint including the trained model to the project; and
generating, by the data processing system, data causing the graphical user interface to display an indication of the blueprint including the trained model.

13. The method of claim 12, wherein the project comprises:
the plurality of blueprints, the plurality of blueprints including the plurality of models trained by machine learning to determine the target based on the list of features to determine the target;
a second plurality of blueprints, the second plurality of blueprints including a second plurality of models trained on a second list of features to determine the target;
the method comprising:
generating, by the data processing system, data causing the graphical user interface to display an indication of the list of features and the second list of features; and
receiving, by the data processing system, via the graphical user interface, a user input that identifies the list of features.

14. The method of claim 12, wherein:
the project comprises:
a second plurality of blueprints, the second plurality of blueprints including a second plurality of models trained on a second list of features to determine the target; and
the method comprising:
receiving, by the data processing system, a user input via the graphical user interface that identifies the second list of features;
comparing, by the data processing system, a number of the second plurality of models to a threshold to determine that the number of the second plurality of models is less than the threshold; and
generating, by the data processing system, data causing the graphical user interface to display an indication that the number of the second plurality of models is less than the threshold.

15. The method of claim 12, comprising:
comparing, by the data processing system, a plurality of performance levels of the plurality of blueprints including the plurality of models with a second plurality of performance levels of a second plurality of blueprints including a second plurality of models of the plurality of projects;
selecting, by the data processing system, a particular project from the plurality of projects based on the comparison; and
selecting, by the data processing system, the blueprint including the model from a plurality of particular blueprints including a plurality of particular models of the particular project.

16. The method of claim 12, comprising:
fitting, by the data processing system, a plurality of performance levels of the plurality of blueprints including the plurality of models of the project and a plurality of particular performance levels of a plurality of particular blueprints including a plurality of particular models of a particular project of the plurality of projects to a linear relationship;
determining, by the data processing system, a level of the fit to the linear relationship;
selecting, by the data processing system, the particular project from the plurality of projects responsive to the level satisfying a threshold; and
selecting, by the data processing system, the blueprint including the model from the plurality of particular blueprints including the plurality of particular models.

17. The method of claim 12, comprising:
generating, by the data processing system, a first vector including a plurality of performance levels of the plurality of blueprints including the plurality of models;
generating, by the data processing system, a second vector including a plurality of particular performance levels of a plurality of particular blueprints including a plurality of particular models of a particular project of the plurality of projects;
computing, by the data processing system, a cosine of an angle formed by the first vector and the second vector;
selecting, by the data processing system, the particular project from the plurality of projects responsive to the cosine of the angle or the angle satisfying a threshold; and
selecting, by the data processing system, the blueprint including the model from the plurality of particular blueprints including the plurality of particular models.

18. The method of claim 12, comprising:
performing, by the data processing system, singular value decomposition to decompose the plurality of projects into a representation of the plurality of projects;
identifying, by the data processing system, based on the representation of the plurality of projects, a particular project of the plurality of projects; and
selecting, by the data processing system, the blueprint including the model from a plurality of particular blueprints including a plurality of particular models of the particular project.

19. A non-transitory computer-readable medium storing process-executable instructions that, when executed by one or more processors, cause the one or more processors to:
receive, via a graphical user interface from a client device, a request to search for one or more blueprints including one or more models to add to a project configured to deploy the one or more models trained via machine learning;
identify, based on a selection received from the client device via the graphical user interface, a list of features with which to execute the requested search;
provide, responsive to execution of the search with the list of features, a blueprint comprising a model selected from a plurality of projects established via input from a plurality of client devices different from the client device, the plurality of projects including a plurality of blueprints, the plurality of blueprints including a plurality of models trained by machine learning to determine a target based on a list of features;
train, via machine learning, the model of the blueprint to determine the target and add the blueprint including the trained model to the project; and
generate data causing the graphical user interface to display an indication of the blueprint including the trained model.

20. The computer-readable medium of claim 19, wherein the project comprises:
the plurality of blueprints, the plurality of blueprints including the plurality of models trained by machine learning to determine the target based on the list of features to determine the target;
a second plurality of blueprints, the second plurality of blueprints including a second plurality of models trained on a second list of features to determine the target;
generate data causing the graphical user interface to display an indication of the list of features and the second list of features; and
receive, via the graphical user interface, a user input that identifies the list of features.
